(19) United States
(12) Patent Application Publication
(10) Pub. No.: US 2026/0103405 A1
(43) Pub. Date: Apr. 16, 2026

(54) COF AEROGEL COMPOSITE ADSORBENT FOR PFAS TREATMENT, PREPARATION METHOD AND APPLICATION THEREOF

(71) Applicant: Beijing Technology and Business University, Beijing (CN)

(72) Inventors: Huilin LIU, Beijing (CN); Qing WEI, Beijing (CN); Mingzhang GUO, Beijing (CN); Huijuan YANG, Beijing (CN); Dianwei ZHANG, Beijing (CN)

(73) Assignee: Beijing Technology and Business University, Beijing, BJ (CN)

(21) Appl. No.: 19/420,717

(22) Filed: Dec. 15, 2025

(30) Foreign Application Priority Data
Apr. 23, 2025 (CN) 202510515567.0

(51) Int. Cl. C02F 1/28; B01J 20/26; B01J 20/28; C02F 101/36; C08J 9/28

(52) U.S. Cl. CPC C02F 1/288; B01J 20/265; B01J 20/28047; C08J 9/28; C02F 2101/36; C08J 2205/026; C08J 2305/08

(57) ABSTRACT

The present disclosure discloses a COF aerogel composite for PFAS treatment, preparation method and application thereof, which falls within the field of pollutant adsorption. The composite comprises the following components: 68.18%-70% COF material, 22.73%-90.91% Chitosan solution, and 9.09% trialdehyde phloroglucinol solution. The COF material consists of ETTA (0.0764 mmol, 30 mg), a side functional monomer (0.1528 mmol), and an o-dichlorobenzene/n-butanol solvent (3 mL), wherein the volume ratio of o-dichlorobenzene to n-butanol in the solvent is 1:1, the side functional monomer includes 0.025 mmol TFTDA and 0.127 mmol BFBIM, and the resulting material is designated as COF-F1N5. The series of COF/aerogels synthesized in this present disclosure exhibit ultralight weight, compression resistance, high stability, and minimal specific surface area loss. This overcomes the application limitations of COF powders, facilitates recyclability, and demonstrates excellent adsorption performance toward PFAS.

### TECHNICAL FIELD

The present disclosure relates to the field of pollutant adsorption, in particular to a COF aerogel composite adsorbent for PFAS treatment, preparation method and application thereof.

### BACKGROUND

Perfluorinated and polyfluoroalkyl substances (PFAS) are a class of synthetic compounds in which all or part of the hydrogen atoms directly bonded to the carbon chain are replaced by fluorine atoms. They are widely used in various consumer goods and industrial products. Due to their carcinogenicity, biological toxicity, environmental persistence, and bioaccumulation potential, PFAS are extensively released into environmental media, particularly water systems and food, posing a serious threat to human health.

Covalent organic frameworks (COFs) are porous organic nanomaterials that have been widely applied in the adsorption treatment of PFAS pollutants, owing to their ordered porosity, stability, and tunable functionality. However, in practical applications, COF powders are often used by direct column packing, this powder form tends to agglomerate in real application scenarios, making it difficult to disperse in water, resulting in low flux, challenges in recovery, and potential secondary pollution-thereby greatly limiting its use in aquatic environments. Especially in the context of PFAS adsorption, the inherent hydrophobicity of COFs leads to poor dispersion in water, causing aggregation at the liquid interface and poor permeability. These limitations significantly restrict their application in water treatment, pretreatment, and pre-detection extraction. To address these issues, COFs can be combined with other functional materials to construct hybrid systems that modulate the hydrophobicity of COFs, improve flux, and help overcome the barriers for translating COF technology from the laboratory to practical applications.

Although several studies have reported COF-based aerogel materials, most of them are synthesized in situ, which often leads to low crystallinity and disruption of the ordered pore structure of COFs, thereby compromising their adsorption performance. Moreover, COF aerogels have not yet been reported for PFAS treatment.

Additionally, the COFs used in currently reported COF aerogels are all single-porosity types. In contrast, hierarchical porous COF nanomaterials, which possess two or more ordered porous networks, have been widely used in catalysis, energy storage, and environmental applications. The hierarchically porous structure with ordered pore sizes offers a potential adsorption platform for PFAS with different chain lengths. However, heteroporous COFs also face the same application challenges as conventional COFs. Therefore, developing a COF aerogel composite for PFAS treatment is imperative to overcome the inherent limitations of COFs in practical applications and broaden their applicability. Such a composite constructs a hierarchical pore structure by integrating the macroporous network of the aerogel with the mesoporous and microporous environments of the heteroporous COF material.

Nonetheless, constructing COF aerogels from heteroporous COFs and aerogels remains a significant challenge and has not been reported to date. Accordingly, this patent presents a hierarchical porous COF/aerogel composite designed for the simultaneous adsorptive removal of both long- and short-chain PFAS.

### SUMMARY

In order to solve the above problems, this application proposes a COF aerogel composite adsorbent for PFAS treatment, including the following components: COF material, Chitosan (CS) solution, 2,4,6-Triformylphloroglucinol (TP) solution;
the COF material includes Tetrakis (4-aminophenyl) ethene (ETTA) 0.0382-0.0764 mmol, 15-30 mg, side functional monomer 0.0764-0.1528 mmol, o-dichlorobenzene/n-butanol solvent 1.5-3 mL;
the volume ratio of o-dichlorobenzene/n-butanol in the o-dichlorobenzene/n-butanol solvent is 1:1;
the side functional monomer includes 0.0125-0.025 mmol 2′3′5′6′-tetrafluoro-[1,1′:4′,1″-terphenyl]-4,4′-dicarbaldehyde (TFTDA); 0.0635-0.127 mmol 4,7-bis(4-formylphenyl)-1,3-dimethyl-1H-benzo[d]imidazol-3-ium bromide BFBIM, named COF-F1N5.

A preparation method of COF aerogel composites for PFAS treatment, including:
S1, synthesis of heteropore fluorine-doped cationic COF;
S2, COF/chitosan aerogel composites are synthesized based on heteropore fluorine-doped cationic COF.

In some embodiments, the specific steps of S1 are:
S101, ETTA, side functional monomer and o-dichlorobenzene/n-butanol solvent are mixed to obtain a mixed solution;
S102, acetic acid is added to the primary mixed solution as a catalyst and mixed to obtain a secondary mixed solution;
S103, the secondary mixed solution is degassed and sealed, and the secondary mixed solution is transferred to the muffle furnace to obtain the product solid when it returns to room temperature.
S104, the product solid is washed and filtered to obtain the initial material;
S105, the initial material is vacuum dried overnight to obtain the COF nanomaterial, and the COF powder is obtained after grinding and sieving.

In some embodiments, the specific steps for S2 are:
S201, the chitosan CS is dissolved in acetic acid aqueous solution to form a uniform and transparent CS solution;
S202, COF powder is added to the CS solution and shaken and uniformly dispersed by ultrasonic treatment to obtain a dispersed solution;
S203, TP solution is added to the dispersion solution to form a hydrogel after shaking;
S204, hydrogels are allowed to stand at room temperature without interference to form a highly cross-linked stable hydrogel;
S205, the highly cross-linked stable hydrogel is frozen and vacuum dried to obtain a COF aerogel composite adsorbent.

In some embodiments, the acetic acid content in S102 is 6-10 mol, 0.3-0.6 mL.

In some embodiments, 800-1000 μL acetic acid aqueous solution in S201, 0.2-0.5 mol/L;
subsequently, 200-400 μL, 10-15 mg/L TP solution is added to 5203.

In some embodiments, S101 is mixed with ultrasonic treatment for 15-30 min;
the mixture in 5102 is treated by ultrasonic for 10-30 min;
the degassing seal of the secondary mixed solution in S103 adopts the method of liquid nitrogen degassing through three freezing-pump-thawing cycles;
the temperature of muffle furnace is 120-140° C., and the reaction time is 72-96 hours.

The product solid in 5104 is fully washed and filtered with ultra-dry tetrahydrofuran for 5 times, and then fully washed and filtered with anhydrous ethanol for 3 times.

The initial material in 5105 is vacuum dried overnight at 80-120° C. to obtain the COF nanomaterial.

In some embodiments, shocking 10-20 s in S201;
in S202, 10-20 s, and it is uniformly dispersed and ultrasonic treatment is performed for 10-15 minutes;
in S204, standing for 12-18 hours;
in S205, hydrogel is frozen in a −80° C. refrigerator for more than 12 h;
COF aerogel composite adsorbent is obtained by vacuum freeze-drying of the hydrogel for 36 h.

In some embodiments, the ratio of COF and CS in S202 is 1:3-4:1.

The application of the COF aerogel composite material prepared by the preparation method is applied to the adsorption of PFAS.

In summary, this present disclosure relates to a COF aerogel composite adsorbent for PFAS treatment, along with its preparation method and application. Compared with conventional technologies, the series of COF/aerogels synthesized in this work exhibit an ultra-low density (26 mg/cm³), excellent compressibility (capable of withstanding 100 g of pressure while retaining their original structure), good stability (maintaining structural integrity in water for 30 days), and effective adsorption performance toward PFAS. Notably, COF/CS-4 demonstrates faster adsorption kinetics. In the rapid treatment of PFAS in water, especially in systems containing both long-chain and short-chain PFAS, the adsorption of short-chain PFAS is enhanced. When compared to commercial adsorbents, the COF aerogels significantly improve the adsorption treatment of PFAS in water, while also ensuring structural stability in aquatic environments.

The technical method of the present disclosure is further elaborated below with the aid of drawings and specific examples.

### BRIEF DESCRIPTION OF THE DRAWINGS

FIG. 1 is the morphological diagram of five aerogels in the example. In FIG. 1, a is the morphological diagram of CS aerogel, b is the morphological diagram of COF/CS-1 aerogel, c is the morphological diagram of COF/CS-2 aerogel, d is the morphological diagram of COF/CS-3 aerogel, and e is the morphological diagram of COF/CS-4 aerogel.

FIG. 2 is the state diagram of the aerogel placed on the fine hairs of Setaria viridis in the embodiment, FIG. 2 a is the state diagram of CS aerogel, FIG. 2b is the state diagram of COF/CS-4 aerogel;

FIG. 3 is the change of five kinds of aerogels placed in ultrapure water with time. In FIG. 3, a is the state diagram of five kinds of aerogels for 24 h, b is the state diagram of five kinds of aerogels for 48 h, c is the state diagram of five kinds of aerogels for 72 h, d is the state diagram of five kinds of aerogels for 96 h, e is the state diagram of five kinds of aerogels at Day 15, f is the state diagram of five kinds of aerogels at Day 30.

FIG. 4 shows that COF/CS-4 can withstand 100 g weight in the example.

FIG. 5 is the recovery process diagram of COF/CS-4 under different proportional pressures in the example.

FIG. 6 is the isothermal adsorption and nonlinear fitting diagram of five aerogels in the example. In FIG. 6, a is the isothermal adsorption and nonlinear fitting diagram of PFOA by five aerogels, and b is the isothermal adsorption and nonlinear fitting diagram of GenX by five aerogels.

FIG. 7 is the schematic diagram of the removal rate of PFOA by different COF aerogels in the example;

FIG. 8 is the schematic diagram of Gen X removal rate by different COF aerogels in the example;

FIG. 9 shows the comparison between COF/CS-4 and commercial adsorbents in the isothermal adsorption test. In FIG. 9, a is the comparison between COF/CS-4 of PFOA and commercial adsorbents. In FIG. 9, b is the comparison between COF/CS-4 of GenX and commercial adsorbents.

FIG. 10 shows the comparison of COF/CS-4 and commercial adsorbents in the adsorption kinetics test. In FIG. 10, a is the comparison of adsorption kinetics between COF/CS-4 of PFOA and commercial adsorbents. In FIG. 10, b is the comparison of adsorption kinetics between COF/CS-4 of GenX and commercial adsorbents.

### DETAILED DESCRIPTION OF THE EMBODIMENTS

The following is a further explanation of the technical method of the present disclosure with reference to the accompanying drawings and examples. It should be noted that, unless otherwise specified, the relative arrangement, numerical expressions, and values of the components and steps described in these examples shall not limit the scope of the present application.

The following description of at least one exemplary embodiment is provided for illustrative purposes only and is in no way intended to limit the application, its uses, or its applications.

Techniques, systems, and equipment known to those of ordinary skill in the relevant technical field may not be discussed in detail; however, where appropriate, such techniques, systems, and equipment are to be considered as part of the specification.

In all examples shown and discussed herein, any specific value should be interpreted as illustrative only and not as restrictive. Therefore, other instances of the exemplary embodiments may have different values.

Unless otherwise defined, technical and scientific terms used in the present disclosure shall have the meanings commonly understood by a person of ordinary skill in the art to which this present disclosure belongs.

The three-dimensional network structure of the aerogel enhances the dispersion and mechanical stability of COF in aqueous media, thereby overcoming the limitations of COF in practical applications. By integrating the biocompatibility of chitosan, the high specific surface area of COF, and the hierarchical pore structure of the aerogel, this approach aims to overcome the technical bottlenecks of conventional PFAS adsorbents, such as low adsorption capacity, slow kinetics, and high environmental risk, and to provide a new strategy for the green and efficient removal of PFAS from complex water systems.

A method for preparing COF aerogel composites for PFAS treatment comprises the following steps:

S1: Synthesis of heteroporous fluorine-doped cationic COF, with the specific steps as follows:

In a glass tube, 0.0764 mmol (30 mg) of ETTA is added, followed by 0.1528 mmol of a side functional monomer (0.025 mmol TFTDA/0.127 mmol BFBIM, designated as COF-F1N5). Then, 3 mL of a mixed solvent of o-dichlorobenzene and n-butanol (1:1, v/v) is added, and the mixture is ultrasonicated for 15 minutes to ensure thorough mixing. Subsequently, 6 mol (0.3 mL) of acetic acid is added as a catalyst, and the tube is immediately ultrasonicated for another 10 minutes. The system is then degassed via three freeze-pump-thaw cycles and quickly sealed under liquid nitrogen. After returning to room temperature, the sealed tube is transferred to a muffle furnace and reacted at 120° C. for 72 hours. After the reaction, the product is thoroughly washed and filtered five times with anhydrous tetrahydrofuran, followed by three washes with anhydrous ethanol. Finally, the washed material is vacuum-dried overnight at 80° C. to obtain the COF nanomaterial, which is then ground and sieved to obtain the COF powder.

TABLE 1
Different proportions of COF and CS

| | | | | | Acetic |
|---|---|---|---|---|---|
| | | COF | | Capacity of | acid |
| | Chitosan | Powder | Crosslinker | the political | content |
| Materials | (mg) | (mg) | (mg) | system (mL) | (μL) |
| CS | 20 | 0 | 2 | 1 | 6 |
| COF/CS-1 | 15 | 5 | 2 | 1 | 6 |
| COF/CS-2 | 10 | 10 | 2 | 1 | 6 |
| COF/CS-3 | 6.67 | 13.33 | 2 | 1 | 6 |
| COF/CS-4 | 5 | 15 | 2 | 1 | 6 |

COF/chitosan aerogel composites are synthesized based on heteroporous fluorine-doped cationic COF. The ratios of COF to CS used in different samples are listed in Table 1. The specific procedures are as follows.

### Example 1

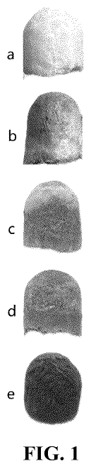

First, 20 mg of chitosan (CS) is dissolved in 800 μL of an aqueous acetic acid solution (0.2 mol/L) and shaken for 10 s to form a uniform and transparent CS solution. Subsequently, 200 μL of TP solution (10 mg/L) is added and shaken for 10 s, after which the mixture is immediately subjected to ultrasonication until hydrogel formation occurs, as shown in panel a of FIG. 1.

### Example 2

First, 15 mg of chitosan (CS) is dissolved in 800 μL of an aqueous acetic acid solution (0.2 mol/L) and shaken for 10 s to form a uniform and transparent CS solution. Then, 5 mg of powdered COF material is added to the CS solution, shaken for 10 s, and ultrasonicated for 10 minutes to achieve uniform dispersion. Subsequently, 200 μL of TP solution (10 mg/L) is added and shaken for 10 s, followed by immediate ultrasonication until a hydrogel forms. The mixture is left undisturbed at room temperature for 12 hours to form a highly cross-linked stable hydrogel. The resulting hydrogel is placed in a −80° C. freezer for over 12 h, and the frozen COF aerogel is finally vacuum freeze-dried for 36 h to obtain a COF aerogel composite adsorbent, as shown in FIG. 1b.

### Example 3

First, 10 mg of chitosan (CS) is dissolved in 800 μL of an aqueous acetic acid solution (0.2 mol/L) and shaken for 10 s to form a uniform and transparent CS solution. Then, 10 mg of powdered COF material is added to the CS solution, shaken for 10 s, and ultrasonicated for 10 minutes to achieve uniform dispersion. Subsequently, 200 μL of TP solution (10 mg/L) is added and shaken for 10 s, followed by immediate ultrasonication until a hydrogel forms. The mixture is left undisturbed at room temperature for 12 hours to form a highly cross-linked stable hydrogel. The resulting hydrogel is placed in a −80° C. freezer for over 12 h, and the frozen COF aerogel is finally vacuum freeze-dried for 36 h to obtain a COF aerogel composite adsorbent, as shown in FIG. 1c.

### Example 4

First, 6.67 mg of chitosan (CS) is dissolved in 800 μL of an aqueous acetic acid solution (0.2 mol/L) and shaken for 10 s to form a uniform and transparent CS solution. Then, 13.33 mg of powdered COF material is added to the CS solution, shaken for 10 s, and ultrasonicated for 10 minutes to achieve uniform dispersion. Subsequently, 200 μL of TP solution (10 mg/L) is added and shaken for 10 s, followed by immediate ultrasonication until a hydrogel forms. The mixture is left undisturbed at room temperature for 12 hours to form a highly cross-linked stable hydrogel. The resulting hydrogel is placed in a −80° C. freezer for over 12 h, and the frozen COF aerogel is finally vacuum freeze-dried for 36 h to obtain a COF aerogel composite adsorbent, as shown in FIG. 1d.

### Example 5

First, 5 mg of chitosan (CS) is dissolved in 800 μL of an aqueous acetic acid solution (0.2 mol/L) and shaken for 10 s to form a uniform and transparent CS solution. Then, 15 mg of powdered COF material is added to the CS solution, shaken for 10 s, and ultrasonicated for 10 minutes to achieve uniform dispersion. Subsequently, 200 μL of TP solution (10 mg/L) is added and shaken for 10 s, followed by immediate ultrasonication until a hydrogel forms. The mixture is left undisturbed at room temperature for 12 hours to form a highly cross-linked stable hydrogel. The resulting hydrogel is placed in a −80° C. freezer for over 12 h, and the frozen COF aerogel is finally vacuum freeze-dried for 36 h to obtain a COF aerogel composite adsorbent, as shown in FIG. 1e.

The morphology of the five aerogels is shown in FIG. 1. The color of CS aerogel is white. As the proportion of incorporated COF increases, the color of the COF/CS aerogels gradually darkens.

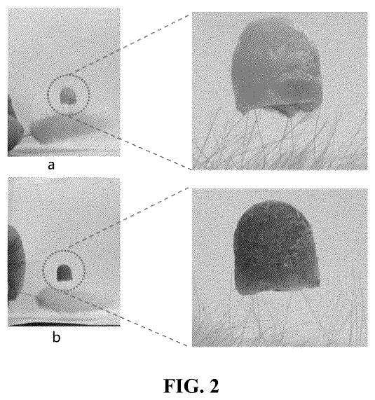

The COF/CS aerogel exhibits low density (ranging from 22.27 to 26 mg/cm³) and ultra-light characteristics, as shown in FIG. 2.

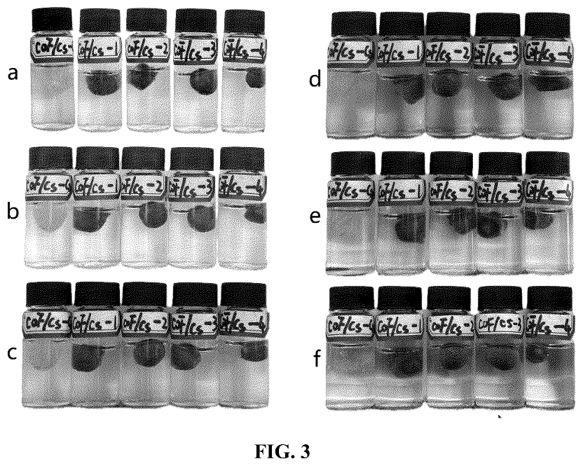

As shown in FIG. 3, the series of synthesized aerogels maintain their original morphology after 30 days in ultrapure water, and consistently float on the liquid surface due to their low density.

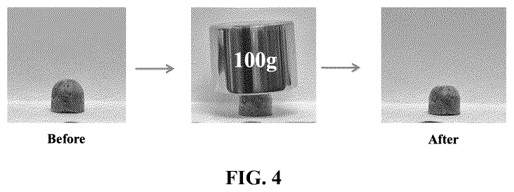

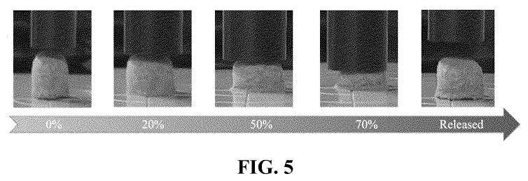

As shown in FIG. 4 and FIG. 5, the aerogels exhibit certain compressibility and self-recovery properties.

In summary, the synthesized series of COF/aerogels possess ultra-light weight, compressibility, good stability, minimal specific surface area loss, and effective adsorption performance for PFAS. In particular, COF/CS-4 demonstrates faster adsorption kinetics, indicating its potential applicability in the rapid treatment of PFAS in water.

### Adsorption Properties of PFAS

The adsorption properties of five COF aerogels are evaluated by isothermal adsorption test and adsorption kinetics test. The adsorption capacity and adsorption rate are calculated by the following formula:

$${q}_{t} = \frac{( {C}_{0} - {C}_{t} ) V}{m} ;$$

$${q}_{e} = \frac{( {C}_{0} - Ce ) V}{m} ;$$

C₀ and Cₑ (mg/L) represent the initial concentration and equilibrium concentration of PFAS, respectively, and C₁ represents the concentration of PFAS at time t. The m (mg) and V (mL) represent the adsorbent mass and solution volume, respectively. Meanwhile, Langmuir and Freundlich adsorption isotherm models are used to fit the adsorption process of two PFASs by heteroporous COF to describe the adsorption process of COF materials in this study.

The Langmuir adsorption isotherm equation is as follows:

$${q}_{e} = \frac{{K}_{L} {q}_{m} Ce}{1 + {K}_{L} Ce} ;$$

Freundlich adsorption isotherm equation formula is as follows:

$${q}_{e} = {K}_{F} {C}_{e}^{1 / n} ;$$

qₘ (mg/g) is the maximum adsorption capacity, K_{L} is the Langmuir constant, KF is the Freundlich constant, and Cₑ (mg/L) is the concentration of PFAS when the adsorption equilibrium is reached.

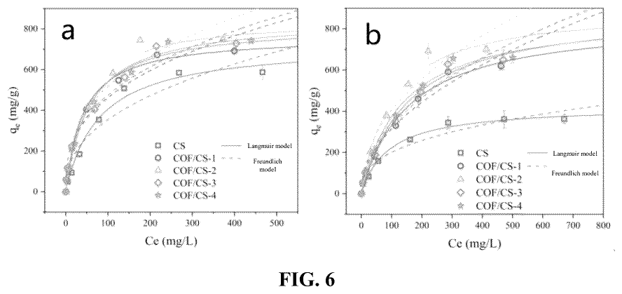

First of all, as shown in FIG. 6, CS aerogels without COF also have a high adsorption capacity for PFOA. With the increase of COF loading, qₑ further increases, and COF/CS-2 reaches the maximum adsorption capacity. It then stabilized.

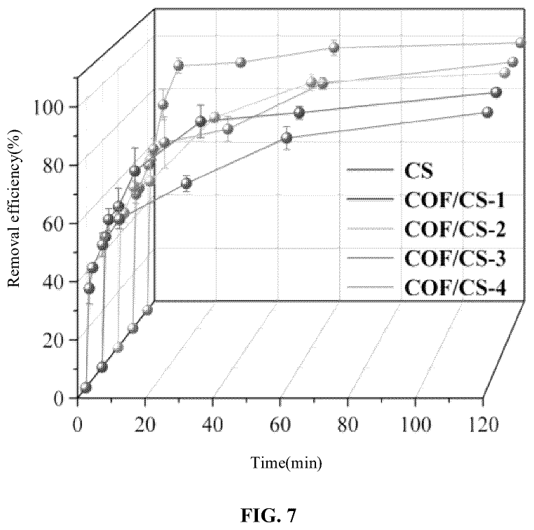

The isothermal adsorption results and nonlinear fitting results of five COF aerogels for GenX (perfluoroalkyl substances) are shown in FIG. 7. Similar to PFOA, CS aerogel without COF also has a certain adsorption capacity for GenX, but it is relatively low. With the increase of COF loading, qₑ increased significantly, and COF/CS-2 also reach the maximum adsorption capacity; it is then stabilized. The fitting results show that the Langmuir model can better describe the adsorption process.

Adsorption kinetics test method: A 30 mL aqueous solution of PFOA or GenX (1 mg/L) is placed in a vial, followed by the addition of the COF aerogel material. The mixture is thoroughly blended and then shaken at 250 rpm at room temperature for predetermined time intervals (2 min, 5 min, 10 min, 15 min, 30 min, 1 h, and 2 h). After each time point, all samples are filtered through a 0.2 m membrane filter. The filtrate is analyzed by UHPLC-MS/MS to determine the residual concentrations of PFOA or GenX. All batch tests are performed in triplicate. The removal rate is calculated, and the adsorption process is modeled using the pseudo-first-order kinetic model and pseudo-second-order kinetic model. The equations for the two models are as follows:

$$In ( {q}_{e} - {q}_{t} ) = {Inq}_{e} - {k}_{1} t ;$$

$$\frac{t}{{q}_{t}} = \frac{t}{{q}_{e}} + 1 / {k}_{2} {q}_{e}^{2} ;$$

qₜ (mg/g) and qₑ (mg/g) represent the adsorption capacity of the adsorbent at time t (min) and equilibrium, respectively. In addition, the quasi-first-order rate constant and the quasi-second-order rate constant are expressed by kᵢ(min⁻¹) and k₂ (g mg⁻¹ min⁻¹), respectively.

According to FIG. 7, although CS aerogel has a good adsorption capacity, the kinetics of pure CS aerogel is poor, reaching nearly 100% removal rate within 120 min. With the incorporation of COF, the adsorption kinetics of COF/CS aerogel is similar to a linear increase, especially the removal rate of COF/CS-4 reaches more than 90% in 10 min.

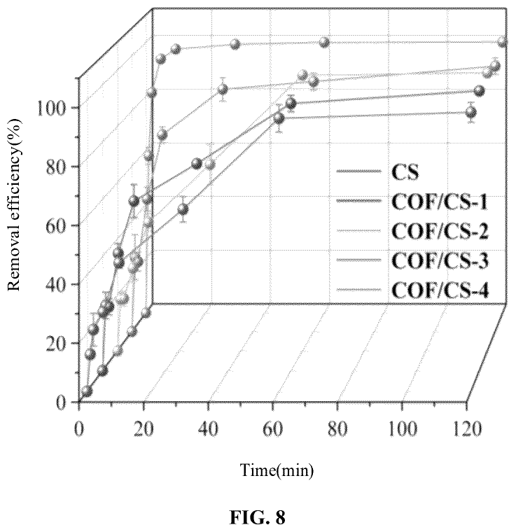

As shown in FIG. 8, for GenX with short chains, pure CS aerogel has poor PFAS dynamics results for ultrashort chains. However, with the incorporation of COF, the adsorption kinetics of COF/CS aerogel also show a similar linear increase. In particular, the removal rate of COF/CS-4 reaches more than 80% in 2 min and more than 90% in 5 min.

Comparison with Commercial Sorbents:

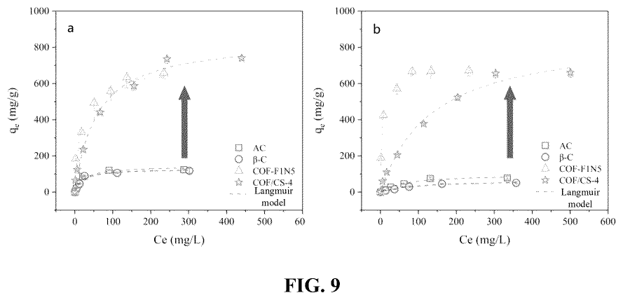

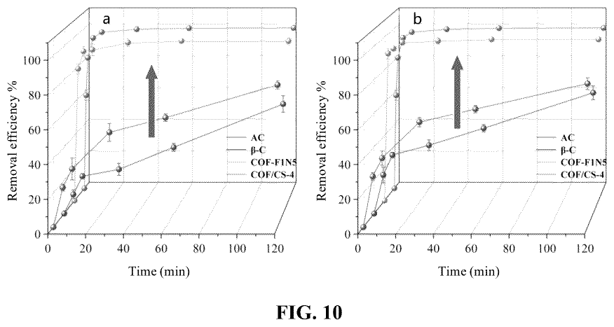

Activated carbon and β-cyclodextrin are among the most commonly used adsorbents. COF/CS-4 and other commercial adsorbents are selected for comparative evaluation of adsorption performance. Isothermal adsorption tests and adsorption kinetics experiments are conducted under the same conditions. The results are shown in FIG. 9 and FIG. 10. Compared with commercial adsorbents such as activated carbon and β-cyclodextrin, the adsorption capacity of the COF/CS-4 aerogel increases by 6 to 7 times, and the time required to reach adsorption equilibrium in kinetics tests is reduced from 120 minutes to less than 15 minutes.

Finally, it should be noted that the above embodiments are provided solely to illustrate the technical approach of the present disclosure and not to limit it. Although the present disclosure has been described in detail with reference to preferred embodiments, those of ordinary skill in the art should understand that modifications or equivalent substitutions to the technical solution of the present disclosure may still be made, and such modifications or equivalent replacements should not cause the amended technical solution to depart from the spirit and scope of the present disclosure.

What is claimed is:

1. A COF aerogel composite for PFAS treatment, comprising the following components:
COF material,
chitosan CS;
a mass ratio of COF material to chitosan CS is 1:3-4:1;
trialdehyde phloroglucinol TP solution;
wherein the COF material comprises 0.0382-0.0764 mmol (15-30 mg) tetra-(4-aminophenyl) ethylene ETTA and 0.0764-0.1528 mmol side functional monomer in 1.5-3 mL o-dichlorobenzene/n-butanol solvent;
wherein a volume ratio of o-dichlorobenzene/n-butanol in an o-dichlorobenzene/n-butanol solvent is 1:1;
wherein the side functional monomer comprises 0.0125-0.025 mmol of 2′,3′,5′,6′-tetrafluoro-[1,1′:4′,1″-terphenyl]-4,4″-dialdehyde TFTDA; and 0.0635-0.127 mmol of 4,7-bis(4-formylphenyl)-1,3-dimethyl-1H-benzo[d]imidazole-3-bromide BFB1M, named COF-F1N5.

2. A preparation method of the COF aerogel composite for PFAS treatment according to claim 1, comprising:
S1, synthesis of heteropore fluorine-doped cationic COF;
S2, synthesis of COF/chitosan aerogel composites based on heteropore fluorine-doped cationic COF.

3. The preparation method of the COF aerogel composite for PFAS treatment according to claim 2, wherein the specific steps of S1 are:
S101, mixing ETTA, side functional monomer and o-dichlorobenzene/n-butanol solvent to obtain a mixed solution;
S102, adding acetic acid to a primary mixed solution as a catalyst and mixing to obtain a secondary mixed solution;
S103, degassing and sealing the secondary mixed solution, and transferring the secondary mixed solution to a muffle furnace to obtain a product solid when it returns to room temperature;
S104, washing and filtering the product solid to obtain an initial material;
S105, vacuum drying the initial material overnight to obtain a COF nanomaterial, and obtaining the COF powder after grinding and sieving.

4. The preparation method of the COF aerogel composite for PFAS treatment according to claim 3, wherein the specific steps for S2 are:
S201, dissolving the chitosan CS in acetic acid aqueous solution to form a uniform and transparent CS solution;
S202, adding COF powder to the CS solution and shaking and uniformly dispersing by ultrasonic treatment to obtain a dispersed solution;
S203, adding TP solution to the dispersion solution to form a hydrogel after shaking;
S204, allowing hydrogels to stand at room temperature without interference to form a highly cross-linked stable hydrogel;
S205, freezing the highly cross-linked stable hydrogel and vacuum drying to obtain a COF aerogel composite adsorbent.

5. The preparation method of the COF aerogel composite for PFAS treatment according to claim 3, wherein the acetic acid content in S102 is 6-10 mol (0.3-0.6 mL).

6. The preparation method of the COF aerogel composite for PFAS treatment according to claim 4, wherein the acetic acid aqueous solution in S201 is 800-1000 μL of 0.2-0.5 mol/L solution;
wherein, subsequently, 200-400 μL of 10-15 mg/L TP solution is added in step S203.

7. The preparation method of the COF aerogel composite for PFAS treatment according to claim 3, wherein mixing in S101 is ultrasonic treatment for 15-30 min;
a mixture in S102 is treated by ultrasonic for 10-30 min;
a degassing seal of the secondary mixed solution in S103 adopts a method of liquid nitrogen degassing through three freezing-pump-thawing cycles;
a temperature of muffle furnace is 120-140° C., and a reaction time is 72-96 hours;
a product solid in S104 is fully washed and filtered with ultra-dry tetrahydrofuran for 5 times, and then fully washed and filtered with anhydrous ethanol for 3 times;
an initial material in S105 is vacuum dried overnight at 80-120° C. to obtain a COF nanomaterial.

8. The preparation method of the COF aerogel composite for PFAS treatment according to claim 4, wherein S201 comprises shocking for 10-20 s;
in S202, COF powder is uniformly dispersed for 10-20 s, and ultrasonic treatment is performed for 10-15 minutes;
S204 comprises standing for 12-18 hours;
in S205, hydrogel is frozen in a −80° C. refrigerator for more than 12 h;
and COF aerogel composite adsorbent is obtained by vacuum freeze-drying of the hydrogel for 36 h;
9. The preparation method of the COF aerogel composite for PFAS treatment according to claim 4, wherein a ratio of COF and CS in S202 is 1:3-4:1.

10. An application of the COF aerogel composite material prepared by the preparation method according to claim 1, wherein the COF aerogel composite is applied to an adsorption of short-chain PFAS in a long-chain and short-chain PFAS co-solution system.
